(19) United States
(12) Patent Application Publication
(10) Pub. No.: US 2017/0007968 A1
(43) Pub. Date: Jan. 12, 2017

(54) FILTER PLATE ASSEMBLY

(71) Applicant: SANI MEMBRANES APS, Værløse (DK)

(72) Inventor: Henrik HJELMSMARK, Værløse (DK)

(21) Appl. No.: 15/116,481

(22) PCT Filed: Feb. 2, 2015
(86) PCT No.: PCT/EP2015/052073

§ 371 Date: Aug. 3, 2016

(30) Foreign Application Priority Data
Feb. 3, 2014 (DK) PA 2014 70049

(51) Int. Cl. B01D 63/08; B01D 65/02

(52) U.S. Cl. CPC B01D 63/084; B01D 63/082; B01D 65/02; B01D 2313/146; B01D 2313/125

(57) ABSTRACT

A novel embodiment of a Filtration Unit with cleanable permeate side, formed by an internally channeled flat filter plate (1) formed by bonding of two flat half filter plates (2, 3), the filter effect formed by perforation slits or holes (10) in the surface of the plates, said perforations connecting to channels (9) inside the plate. The channels inside the plates are for permeate leading to two or more paired exits (4, 5) perpendicular to the plate, the plate exits forming exit channels for permeate to exit the Filtration Unit. The paired exits makes it possible to clean the permeate site of the Filtration Unit by flushing cleaning media from one exit (4 or 5) to the other exit (4 or 5). The filter area surface (6) can be covered by bonding a fine filter (7), typically an organic flat sheet membrane, to the filter surface, whereby very fine micro or ultra filtration or even molecular filtration can be achieved.

The present invention relates to a filter plate assembly comprising at least one filter plate configured for cross-flow filtration, said filter plate comprising a first and a second rigid planar square or rectangular surface enclosing at least two internal permeate channels, said first and second surface comprises perforations, being in fluid connection with said internal permeate channels.

### FIELD OF THE INVENTION

The invention relates to fine filtration or microfiltration, ultrafiltration and to molecular (Nano and RO) filtration.

The term fine filtration applies to filtration through slits or holes in the filter plates of 50 to 500 microns whereas microfiltration is usually applied to particle sizes of a media suspension between a few hundredths of micrometers and to tens of micrometers and is carried out at low differential pressure from just above zero to a few bars. Micro filtration is as example used for sterile filtration of milk. Ultrafiltration is used for example for separating the large organic molecules from mineral molecules or small organic molecules and a higher differential pressure is needed for example between 1 and 15 bars, for Nano and Reverse Osmoses even higher differential pressures are needed and a Filtration Unit must then be adequately designed to withstand the high differential pressure.

The term permeate is used for the media that has passed through the filter and the term retentate relates the media to be filtered.

### DESCRIPTION OF THE PRIOR ART

Plate type filtration modules are used as Submerged Assemblies, Plate and Frame units or In Channel variants.

Submerged assemblies are typically used for Membrane Bio Reactors and a number of prior designs are available, typically large flat sheet elements (TW200920471, US2013043189) with little focus on clean ability, as they anyway operate with waste water, or as guard filter for very clean water.

The Plate and Frame units are typically used for pharma or biopharma process industry applications and these units often have free flow filtration capability. As the plates are pressed together in a frame the units have lots of long joints, prone to leakage. A variant of prior art is the Fluid Separating Apparatus mentioned in GB1381681, where membrane is glued into a channeled plate assembly in a plate-and-frame squeeze type unit. These Plate and Frame Filtration Units also have a very high square meter price as they are very complicated and highly technical units.

The In Channel Plate units such as the flat filtering elements described in U.S. Pat. No. 4,816,150, JP20088183561, or in U.S. Pat. No. 5,626,752, describing flat membrane cushions or pads are so far formed as a complex assembly of individual components—membrane cushions or flat sheet membranes pressed together in various ways whereby permeate exits are separated from media to be filtered with some type of gasket or sealing effect, either created by a squeezed or pinched gasket or the membranes functioning as gasket.

A built up type of plate filter unit such as JPS59062323 is based on round, disc shaped plates, built up of two half plates with one central exit for permeate.

All the known membrane filter element types including those mentioned above, all have non directional regulated permeate flow, whereby the permeate side cannot be cleaned by a flushing of cleaning media, rather they a cleaned through soaking of the permeate side when cleaning media enters through the membrane side and are then organically and bacteria wise cleaned when high temperature cleaning media is applied. (An example is the composite membranes as shown in KR2011 0008224, plate and frame module WO2011019278 or filter pad EP0129663). The same unregulated and not flushable permeate side limit efficiency of applications where a concentration boundary layer builds on the permeate side, typically gas applications.

Furthermore, filter plate units are generally configured to achieving low pressure los and optimize filter capacity relative to the size of the filter plates.

### DESCRIPTION OF INVENTION

It is an object of the present invention to provide a filter plate assembly that solves one or more of the above problems.

This is achieved by a filter plate assembly, wherein said filter plate comprises at least a first and a second permeate exit and where each internal permeate channel extends from said first permeate exit to said second permeate exit, said perforations comprise slits or holes, said slits or holes are formed conically with smaller opening to outside the filter plate and widening up towards the internal permeate channels.

Hereby it is achieved the possibility to clean the permeate side of the filter plate by flushing of cleaning media from first permeate exit to second permeate exit, and the permeate site will avoid blockage of flow, and the conical form support a pressure gradient between retentate and permeate, while allowing for flush flow in the permeate channel.

At the same time the said permeate channels and connected exits allows for unimpeding drainage of permeate improving flux of filtration area.

In an embodiment, said at least two permeate exits extends transversely to said planar surface of said filter plate. The perpendicular exits allow for a large access area to the permeate channels and thus high flow speeds between the two exits during cleaning operation, and at the same time the large channels reduces counter pressure of permeate exit.

In an embodiment, said filter plate comprises a protrusion, said protrusion constitute said permeate exits. The protrusions, when the filter plates are stacked together, form the permeate exit, keeping the number of parts to a minimal.

In an embodiment, said filter plate comprises at least one filter sheet positioned adjacent to said first and second perforated outer surface of said filter plate. Hereby, the filter plate assembly may comprise two layers of filters with different properties, and a very fine micro filtration or ultrafiltration is achieved depending on the selected membrane as additional perforation filter.

In an embodiment, said filter plate comprises two half plates which are bonded together at the periphery of the two half plates and said two half plates being identical in shape keeping the number of parts to a minimal. The bonding area seals permeate inside the filter plate from the retentate outside the filter plate.

In another embodiment, said filter plate assembly comprises a plurality of filter plates, said filter plates are situated parallel juxtaposed having the perforated surface facing the perforated surface of an adjacent filter plate, said plurality of filter plates forming a square or rectangular entry for a media to be filtered, such that said media is able to pass between the filter plates allowing for a large membrane area on a small foot print.

In an embodiment, said filter plate assembly comprises at least two permeate exits, said at least two permeate exits of each filter plate combined forms said two combined permeate exit extending transversely to said planar surface of said filter plates. Said combined permeate exits can be sealed closed on one side of the plate assembly reducing number of connections, and still allowing the flush through function of the invention.

In an embodiment, said filter plate comprises one or more bonding points for bonding two adjacent filter plates, said bonding points together with the protruding permeate exits defining the distance between two filter plates.

In an embodiment, said filter plate assembly is composed by a plurality of identically shaped half filter plates, and where the permeate exits are formed by integrated parts of said half filter plates.

In an embodiment, said at least two permeate exits are positioned away from each other having said first permeate exit at the entry for a media to be filtered, and having said second permeate exit at the retentate exit. Hereby, it is possible to clean the filter plate assembly effectively by flushing.

An embodiment of a Filtration Unit with cleanable permeate side in form of an internally channeled typically rectangular, rigid, flat filter plate, said plate formed by bonding of two flat half filter plates, the filter effect formed by perforation slits or holes in the surface of the half plates, said perforations connecting to channels in the plates so that the bonded plates have filter area on both sides with a plural of permeate flow channels where the half plates meet. The two half plates can be exact equals or of different design however with similar perforation and hence a uniform filtration function.

The inside purposely shaped channels for permeate then lead to paired exits perpendicular to the plate, the plate exits forming exit channels for permeate from the Filtration Unit. These exits can then be used for cleaning of permeate side, when during cleaning, cleaning media is entered through one exit and exit the other exit, the permeate channels are cleaned with a flushing flow of cleaning media. If convenient, one side of the exits can be sealed of limiting number of connections, while still keeping clean ability through channels connecting exits. The amount of perforations is maximized in the filtration areas of the plate, however limited by possible density of connected channels for permeate connecting to paired exits, as the plate must be rigid enough to withstand operation and must be designed to withstand the differential pressure between media and permeate flows.

The filter plates can be stacked together from a few plates, to many dozens of plates in one bonded Filtration Unit. The filter plates are then stacked with spacing for of media to be filtered, offering gap outside for access or flow of media to be filtered.

The filtering surface can be covered by a fine filtering surface, securing a sealed bonding of the fine filter, typically an organic flat sheet membrane, whereby very fine micro or ultrafiltration or even molecular filtration can be achieved.

The plural of channels in the filter plates connecting the paired exits are so formed that the permeate can leave the plate with negligible pressure loss from entry into the plate to the plate exit and so that the channels can be cleaned during CIP (Clean In Place) by a flow of cleaning media from one exit to the other. The permeate discharge is hence not a random flow arrangement, rather a controlled channeled stream that can be flushed and so cleaned from one end to the other via the paired exits. This flushing capability can also be used in some applications where a sweeping of the permeate side is needed.

The invention provides then a Filtration Unit which has, with respect to known filtration and membrane Filtration Units, the advantages of having at the same time, a cleanable permeate side, a free flow of the liquid stream to be filtered, defined by distance between filter plates (1 to 6 mm) if stacked, the filter plates being of limited thickness however rigid (3-6 mm thick, consisting of 2 bonded half plates) making a compact unit possible, the Filtration Unit having a limited length of the path of the liquid to be filtered (10 to 100 cm) and a non-impeding short (5 to 50 cm) but relatively large diameter (about half of filter plate thickness) plural of draining leading channels for permeate discharge leading to paired larger perpendicular exit channels, and an overall structure, having sufficient mechanical strength for it to keep a constant geometry, guaranteeing the stability of the hydrodynamic conditions, under pressure, media and temperature constraints and at a satisfactory constructional cost.

The filtration slits or holes are formed conically with smaller opening to outside and widening up towards the channel, thereby securing that a minimal of blocking will take place in the permeate exit path. The slits or holes are dimensioned to needed degree of filtration, typically 50-500 micron.

Preferred perforation filter slits are 100-150 micron wide by 5 mm long, spaced 5 mm in between, ensuring sufficient area for permeate exit, while at the same time supporting the plate for differential pressure and maintaining a rigid plate function. When covered with membrane cloth, these filter slits ensure sufficient area for permeate exit and support the membrane for trans-membrane pressure.

The filter plates are sized according to need for filtration area and are typically from 10 by 10 cm of filter area up to 50 by 100 cm filter area, the typical size for industrial applications being 20 by 20 cm up to 20 by 100 cm.

The flat filter plates are typically 4-6 mm thick with permeate channels typically around half of the plate thickness in diameter under the filter area, the filtering area being formed by slits or holes leading to the plate surface from the channels. The channels lead to plate exits that are sized to lead all permeate from the Filtration Unit to the exit with negligible pressure loss, typically the plate exits are 10-50 mm in diameter.

The bonded plates each form a (perforated) pressure vessel so that when a back flow and pressure is applied from the exit a back flushing of the perforation can take place there by cleaning the active filter area—the slits or holes or the attached membrane or fine filter.

In a tested and proven execution of the invention, the filter plate assembly consist of rigid plastic molded plates in a stack of 33 filter plates, each 200 mm wide 4 mm thick, with 2 mm spacing between plates, the stack thus having a rectangular retentate cross flow ‘inlet form’ of 200×200 mm. Each filter plate designed with a filter area on each side of approx. 200×200 mm. Each filter plate is build up by 2 equal half plates, 2 mm thick, molded with 16 off equally spaced half 2 mm internal permeate channels connecting in either end to 16 mm perpendicular protruding permeate entry/exit holes. The half channels are designed with a plural of conical slits with 0.1×5 mm perforations. When the half plates are joined, the internal permeate channels 2 mm are formed an when these filter plates then are stacked, 16 mm manifold channels are formed in the stack via the protruding exits, 2 channels then giving 4 exits/entry points to the permeate side. The stack is made rigid by the bonded permeate channels and added bonding members fixed to the side of the stack, joining the filter plates rigidly at several points with the selected plate spacing of 2 mm.

This described execution thus supports a flush cleaning flow of permeate side where turbulent flush cleaning of all internal channels can be achieved. Turbulent flush cleaning flow in the larger permeate exits as well as in the smaller permeate channels can be secured with little pressure difference of 0.1 bar, by a cleaning flow of approx. 7 m3/h to paired permeate channels. To avoid backpressure during permeate flushing the retentate pressure should be kept slightly higher.

The rigid bonded structure allows for the Filtration Unit to be exposed to a mechanical movement in parallel to the filter plates during operation, given flexible connections to the Filtration Unit. This movement of the filter surface in relation to the media to be filtered, can with little use of energy, keep the filter surface clean and secure lower the concentration gradient of media close to the filter surface, thereby increasing flux of permeate per square meter filter area and keep the filter operational for longer time.

Materials used for the Filtration Unit are typically polymeric or co-polymeric thermoplastic but can be of metallic origin or any other suitable material that can withstand the media to be filtered, the temperature span needed, typically 5-75 Degrees Celsius as well as the medias used for cleaning the Filtration Unit. Also the choice of material must foresee thermal expansion and rigidity of the unit. Preferred execution is filtration plates in molded plastic such as Polypropylene and with a polymeric membrane used as fine filter, both materials readily accessible in food grade versions on the market. Other executions can be as sintered parts or 3 D printed versions in various materials.

Bonding of the Filtration Unit parts into one unit including half plate to half plate bonding, fine filter to filter plate bonding and filter plate to stack bonding may be by laser welding, direct or indirect heat welding, ultrasonic welding, use of glue or solvents or mechanically bonding with mechanical elements or connections designed into the parts. In the preferred execution plastic parts are welded together through heat applied melting of very specific areas of the designed parts, said filter plate parts being molded by injection molding of polymer thermoplastic.

### DESCRIPTION OF THE DRAWINGS

Other features and advantages of the invention is disclosed in the following description, with reference to the accompanying drawings wherein

FIG. 1 is a perspective view of a filter plate,

FIG. 2 is an exploded perspective view of a filter plate,

FIG. 3 is cross-sectional views perpendicular to the longitudinal extension of the filter plate, showing two permeate channels,

FIG. 4 is a perspective view of a filter plate assembly.

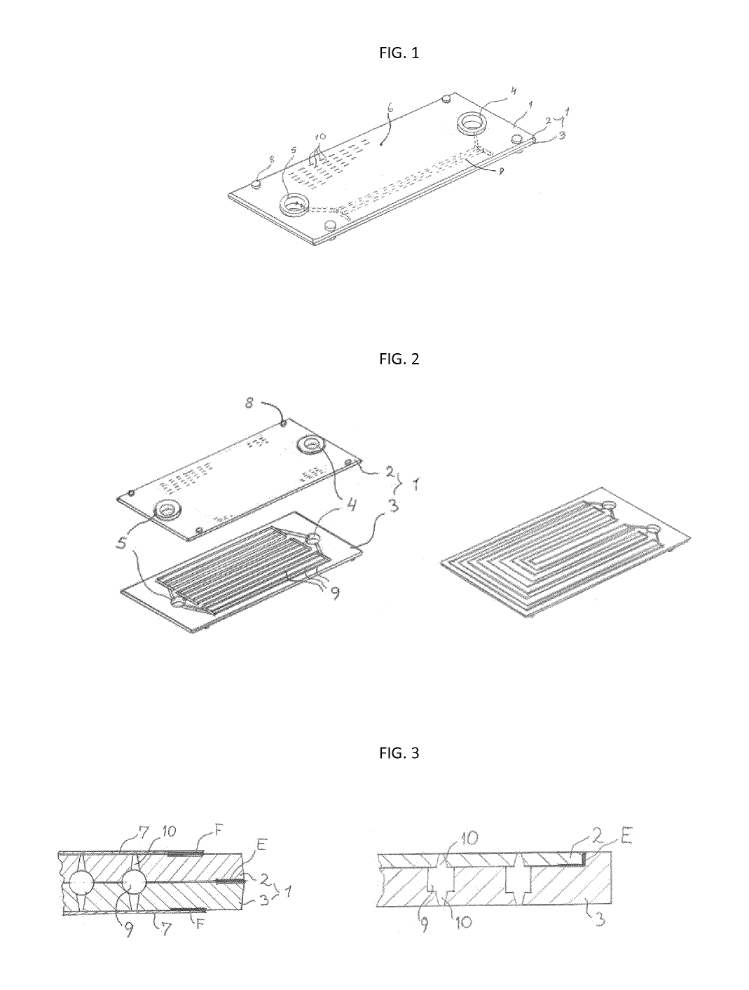

FIG. 1 Illustrates one embodiment of the Filtration Unit in form of one filter plate (1) formed by a bonding of two half filter plates (2, 3). In the illustrated embodiment, the permeate exit (4, 5) of the Filtration Unit is on either side of the filtration area (6) and the filtration area is not shown with a fine filtering element covering the numerous slit shaped perforations (10). As indicated a number of channels (9) connect the two permeate exits on each filter plate and the perforations lead to the channels. The permeate exits can be sealed off at one side of the unit, depending on need for exit area.

FIG. 2 Illustrates two half filter plates (2, 3) in an exploded view, showing the inside permeate channels (9) of a filter plate connecting the filter plate exits (4, 5) and also shown are a variation in layout of inside channels. The channels (9) may be joined in a manifold like channel before connecting to the larger exit holes (4, 5). The exit holes can be placed as convenient, for example in opposite corners or side by side, considering short and efficient drainage channels (9) for the permeate. In a larger plate, more paired exits may be needed to secure drainage as well as cleaning of the permeate side.

The filter plate (1) comprises bonding points (8), the bonding points also functioning as distance point together with the protruding permeate exits, such that the media to be filtered can pass the filter plate assembly (20) in-between two adjacent filter plates (1). In FIG. 2 is illustrated four bonding points (8), and they are positioned at the periphery of the filter plate to avoid obstruction of the media to pass the filter plate assembly (20).

The bonding points (8) are illustrated as a solid cylinder shaped protrusion extending transversely to the surface of the filter plates (1). Alternative the distance between plates can be supported by a mechanical member positioned at the edge of the filter plate assembly.

FIG. 3 Illustrates details of a filter plate with example of the conical perforation (10) of the filter plates leading to permeate channels (9) in the filter plate and (E) illustrates bonding area of half filter plates (2, 3) and (F) bonding areas of fine filter cloth (7) on both side to filter plate. In the figure the two half plates (2,3) are bonded at the periphery (E). Also shown are an example of a filter plate made up by two not identical half filter plates, where the channels are predominantly formed in one half. The bonding (E) of the two half plats must secure a complete sealing of the inside of the bonded filter plates all along the edge, so that filtrate only enters the permeate side at designated filtration area. To ensure rigid filter plates, the filter plates may be bonded at various points within plate area, when two half filter plates (2, 3) are bonded into one filter plate (1).

The filter (7) is bonded to the surface of a half plate (F). The bonding (F) of the fine filter, when this is relevant for the application of the Filtration Unit, on the two sides of the filter plats, must likewise secure a complete sealing of the inside of the bonded filter plate all along the edge, so that filtrate only enters the permeate side at designated filtration area. To ensure rigid fixation of the fine filter to the filter plates, the fine filter may be bonded at various points within edge, as this will allow for trouble free back washing or back flushing of the fine filter.

Experiments have shown that a filter plate made by injection molding in plastic of 2 half plates of 2 mm plate thickness and with 2 mm permeate channels give a good rigid structure for 20 cm wide an 90 cm long filter plate and that slits of 0.1 mm by 5 mm that are spaced 5 mm sideways and longitudinal to permeate channel give good drain ability to open microfiltration organic membrane and good support to withstand a high trans membrane pressure of more than 10 bar when needed.

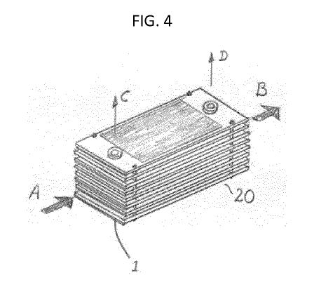

FIG. 4 shows a stack of filter plates formed into a multi plate filtration unit (20) and the flows of filtrate/retentate (A, B) and permeate (C, D). Retentate is the term used for media to be filtered, this can be in form of a liquid stream entering (A) and exiting (B) the filter area in the Filtration Unit in a continuously flowing stream when Filtration Unit is used in a cross flow mode. In the illustration two permeate exits are shown and during CIP cleaning—Cleaning In Place—cleaning media can enter one permeate exit and exit the other, thereby cleaning the permeate side of the Filtration Unit.

The filter plate assembly (20,1) (also called Filtration Unit) comprises filter plates (1). The filter plate assembly comprises a plurality of filter plates (1), said filter plates situated parallel juxtaposed having the perforated surface facing the perforated surface of an adjacent filter plate (1), two adjacent filter plates having a distance of 1 to 6 mm such that said media (A) is able to pass the filter plate assembly (20) between the filter plates (1). The plurality of filter plates (1) forms a square or rectangle entry for the media (A) to be filtered.

The filter plate assembly (20,1) comprises two permeate exits. The cylindrical protrusions (4,5) (as shown in FIGS. 1 and 2) of each filter plate combined forms said two combined permeate exit (4,5) extending transversely to the extension of the planar surface of the filter plates (1).

It goes without saying that different modifications may be made to the examples described, without departing from the scope and spirit of the invention.

Further embodiments are disclosed in the following.

A sanitary Filtration Unit cleanable on the permeate side, formed by a flat elongate rigid filter plate (1) being composed of two half plates (2, 3) bonded at least around edge in a way whereby sealing (E) is secured, the half plates being of substantially identical perforated surfaces on outside, and with a thickness giving room for internal channels (9) in parallel to the flat surface for unimpeded, channeled draining of permeated media entered through the plural of perforations (10), said channels leading to paired exits (4, 5) perpendicular to filter plate surface so that these form the exit channels for permeated media from the stacked Filtration Unit. The permeate channels (9) and hence the permeate or back side of the filter areas in the filter plate can be flushed through during cleaning by entering cleaning media in one of paired exits (for example (4)) and exit the Filtration Unit through the other of the paired exits (for example (5)).

The bonded filter plate shall have a structure to form a sufficient rigid structure of the Filtration Unit providing good dimensional stability under mechanical, thermal and chemical stress.

The Filtration Unit to be used for finer filtration than the filtration offered by the perforations in the filter plates through an added fine filter (7) covering the filter area (6) and where the perforations (10) and the filter plats (1) offer drainage for the fine filter and so the Filtration Unit acts as collector and support for the fine filter, said fine filter being as example a fine mesh sheet or membrane suitable for Micro, Ultra, Nano filtration or Reverse Osmosis filtration, said fine filter bonded to the filter plate fully covering the perforated filter area (6) in a way whereby sealing is secured at the edge. The fine filter (7) is bonded in numerous spots or lines to the filter plate (1) whereby a back flow of filtered permeate can wash the active filter area without damaging the fine filter, and whereby longer filtration time before need for cleaning can be achieved. The fine filter (7) is compounded on the filtration plate either as a membrane formed by spheres or fibers or woven material or molded as an organic membrane or combination of these thereby creating the Micro, Ultra, Nano filtration or Reverse Osmosis filtration, and where the filter plate (1) acts as collector and support for the fine filter (7).

The rigid structure allows for the Filtration Unit to be exposed to a mechanical movement parallel to the filter plate and hence filter surface and to the media to be filtered, keeping the filter surface clean and secure lower the concentration gradient of media close to the filter surface, thereby increasing flux of permeate per square meter filter area and keep the filter operational for longer time.

The filter plate (1) is between 2 and 6 mm thick comprised by two half plates (3, 4) typically molded in plastics or other media withstanding and rigid material and with dimensions giving room for a filtration area from some 10's of square centimeter to some 10's of square decimeter and with and with internal channels for filtered media roughly half the thickness of the filter plate and with numerous conical filtration perforations as slits or holes connecting filter plate surface and the internal channels with perforation openings of 0.05 to 0.50 mm at the surface, said internal channels leading to filter plate exits (4, 5) of typically a diameter of 10 to 50 mm.

The filter plate (1) is stacked and bonded into a unit where the number of stacked filter plates typically compile to form a square size Filtration Unit seen from entry and exit side of flow direction, the opening and free passage for media to be filtered is between 1 and 6 mm between opposite arranged filter plates. It shall be noted that the overall design hereby gives possibility to have many square meters of filtration area in one compact Filtration Unit.

The half plates (2, 3) bonding into edge-wise sealed filter plates and the bonding of edge-wise sealed fine filter (7) onto filter plates (1) and the sealing bonding of filter plate exit to filter plate exit (4, 5) or the bonding of bonding points (8), said bonding can be through direct or indirect or laser or ultrasonic or otherwise applied heat for re-melting material of said parts or for melting added material or for a media to dissolve material or to add glue or to add mechanical fixtures or combination of above to perform a strong bond of the assemblies or subassemblies together forming the Filtration Unit

All parts can be of food and pharmaceutical grade material with traceable origins, making the Filtration Unit suitable for human food consumables and the likes. The materials used are preferably of a plastic material that can be reused by re-melting or burned as a clean fossil-like fuel.

The parts of the unit are produced by 3 D printing or sintering of other means.

1. A filter plate assembly (20, 1) comprising at least one filter plate (1) configured for cross-flow filtration, said filter plate comprising a first and a second rigid planar square or rectangular surface enclosing at least two internal permeate channels (9), said first and second surface comprises perforations (10), being in fluid connection with said internal permeate channels (9), characterized in that said filter plate (1) comprises at least a first (4) and a second (5) permeate exit and where each internal permeate channel (9) extends from said first permeate exit (4) to said second permeate exit (5), and said perforations (10) comprise slits or holes, said slits or holes are formed conically with smaller opening to outside the filter plate (1) and widening up towards the internal permeate channels (9).

2. A filter plate assembly (20, 1) according to claim 1, wherein said at least two permeate exits (4,5) extends transversely to said planar surface of said filter plate (1).

3. A filter plate assembly (20, 1) according to one or more of the preceding claims, wherein said filter plate comprises a protrusion, said protrusion constitute said permeate exits (4,5).

4. A filter plate assembly (20, 1) according to one or more of the preceding claims, wherein said filter plate (1) comprises at least one filter (7) sheet positioned bonded adjacent to said first and second perforated outer surface of said filter plate (1).

5. A filter plate assembly (20, 1) according to one or more of the preceding claims, wherein said filter plate (1) comprises two half plates (2,3), which are bonded together at the periphery of the two half plates and said two half plates being identical in shape.

6. A filter plate assembly (20) according to one or more of the preceding claims, wherein said filter plate assembly (20) comprises a plurality of filter plates (1), said filter plates are situated parallel juxtaposed having the perforated surface facing the perforated surface of an adjacent filter plate, said plurality of filter plates forming a square or rectangular entry for a media (A) to be filtered, such that said media (A) is able to pass between the filter plates (1).

7. A filter plate assembly (20) according to claim 6, wherein said filter plate assembly (20) comprises at least two permeate exits, said at least two permeate exits (4,5) of each filter plate combined forms said two combined permeate exit (4,5) extending transversely to said planar surface of said filter plates (1).

8. A filter plate assembly (20) according to claim 6 or 7, wherein said filter plate comprises one or more bonding points (8) for bonding two adjacent filter plates (1), said bonding points together with the protruding permeate exits (4,5) defining the distance between two filter plates (1).

9. A filter plate assembly according to one or more of the preceding claims, wherein said filter plate assembly is composed by a plurality of identically shaped half filter plates (2,3), and where the permeate exits (4,5) are formed by integrated parts of said half filter plates (2,3).

10. Filter plate assembly according to any one or more of the preceding claims, wherein said at least two permeate exits (4,5) are positioned away from each other having said first permeate exit (5) at the entry for a media (A) to be filtered, and having said second permeate exit (4) at the retentate exit (B).
